(19) United States
(12) Patent Application Publication
(10) Pub. No.: US 2002/0113389 A1
(43) Pub. Date: Aug. 22, 2002

(54) Tipping wheelbarrow

(76) Inventor: Graham Robinson, Stoke on Trent (GB)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/079,758

(22) Filed: Feb. 19, 2002

(30) Foreign Application Priority Data
Feb. 17, 2001 (GB) 0103947.8
Aug. 20, 2001 (GB) 0120210.0

(51) Int. Cl. B62B 7/02

(52) U.S. Cl. 280/47.31

(57) ABSTRACT

A tipping wheelbarrow is described including a main frame providing ground engaging support portions and two rearwardly extending handles, a wheel rotatably mounted via an axle on the main frame towards the front thereof, and a body unit for receipt of a load pivotally mounted on the main frame. The body unit is mounted such that the body unit tips with respect to the main frame when the handles are lifted up. The body unit is mounted on the main frame for pivoting relative thereto about an axis rearwards of the axle and forwards of the ground engaging portions of the main frame. The tip of the body unit is limited by the body unit coming into contact with the wheel.

### CROSS-REFERENCE TO RELATED APPLICATIONS

Priority is claimed to United Kingdom patent applications Serial Nos. 0103947.8 filed Feb. 17, 2001, and 0120210.0 filed Aug. 20, 2001.

### STATEMENT REGARDING FEDERALLY SPONSORED RESEARCH OR DEVELOPMENT

Not Applicable.

### TECHNICAL FIELD

The invention relates to wheelbarrows of the kind used by gardeners and builders, and in particular to ones which tip to assist in emptying them.

### BACKGROUND OF THE INVENTION

A traditional wheelbarrow comprises a frame with a single wheel at the front, a body or container thereon for receipt of a load, and two handles extending rearwardly. Such wheelbarrows have been around for many years and are generally successful. However, they do suffer from the disadvantage that it can be difficult to empty the load out of the body, as to do so if the load is not free flowing demands that the handles are lifted up past the vertical, as shown in FIG. 1, which can be very difficult especially for smaller lighter people.

Over the years many versions of tipping wheelbarrows have been tried, but none have been successful. Some are very complex to manufacture and hence expensive and thus do not sell, whilst others have been too heavy or simply have not worked effectively in use.

Whilst some radical wheelbarrows have been designed, two basic approaches to modification of a conventional wheelbarrow have been used in the prior art. Many wheelbarrows have been designed which are emptied by leaving the main frame resting on the ground and tipping just the load carrying part, known as a body, either with or without the handles attached. If the handles are not attached then in general the user has insufficient leverage to raise the body up with ease. In contrast if the handles are attached to the tipping body then various clips and retaining members are required when pushing the wheelbarrow around.

The other approach has been to tip the body with respect to the main frame when the main frame is lifted by lifting the handles. One version of such an approach is described in U.S. Pat No. 5,121, 970, in which the body is supported on a sub frame pivotally mounted on the main frame right at the front thereof, and a rigid catch arm is provided towards the rear of the sub frame to limit the angle of tip of the sub frame with respect to the main frame. This design does however suffer from the disadvantage that there are moving parts depending down from the body of the wheelbarrow in normal use and these could trap objects, including in particular the hands and feet of children.

Another version of such an approach is described in British patent GB 1,027,076, in which the body is located between a pair of large wheels and pivoted on the frame forward of and above the axle for those wheels. The body appears to tip until it touches the ground, with nothing provided to limit, cushion or control the tip.

It is an object of the present invention to provide an alternative form of tipping wheelbarrow which does not suffer from the same disadvantages as those in the prior art.

### BRIEF SUMMARY OF THE INVENTION

According to the present invention there is provided a tipping wheelbarrow which includes a main frame providing ground engaging support portions and a pair of rearwardly extending handles, a wheel rotatably mounted via an axle on the main frame towards the front thereof, and a body unit for receipt of a load pivotally mounted on the main frame such that the body unit tips with respect to the mainframe when the handles are lifted up. The body unit is mounted on the main frame for pivoting relative thereto about an axis rearwards of the axle and forwards of the ground engaging support portions of the main frame. The wheelbarrow is constructed such that when the wheelbarrow is at rest on the ground, the axle is supported relative to the main frame forward of and below the axis about which the body unit pivots, and a portion of the wheel extends above the axis, wherein the tip of the body unit with respect to the main frame is limited by the body unit contacting the wheel. The wheelbarrow preferably further include a sub frame to which the body is secured to form the body unit, and which is pivotally mounted on the main frame. Preferably, the main frame also has a cross member rearwardly of the ground engaging support portions to support the rear of the body unit when not in the tipped position.

The wheelbarrow may further include means for selectively preventing pivotal movement of the body unit with respect to the main frame. Preferably, the means for selectively preventing pivotal movement of the body unit are automatically engageable. The means for selectively preventing pivotal movement of the body unit may be disengageable when a predetermined load is applied to the body unit.

Other objects and advantages of the invention will become apparent from the following detailed description of the invention and the accompanying drawings.

### BRIEF DESCRIPTION OF THE DRAWINGS

FIG. 1 shows a conventional prior art non-tipping wheelbarrow being emptied;

FIG. 2 is a side elevational view showing a tipping wheelbarrow according to the invention resting on the ground;

FIG. 3 is an exploded perspective view showing the components used to secure the sub frame of the wheelbarrow of FIG. 2 to the main frame thereof;

FIG. 4 is a side elevational view showing the wheelbarrow of FIG. 2 being emptied;

FIG. 5 is a side elevational view of a modified embodiment of a wheelbarrow according to the invention;

FIG. 6 is a fragmentary exploded perspective view showing components used to secure the sub frame of the wheelbarrow to the main frame, for the embodiment of FIG. 5, and

FIG. 7 is a bottom plan view of the wheelbarrow of FIGS. 5 and 6.

### DETAILED DESCRIPTION OF THE INVENTION

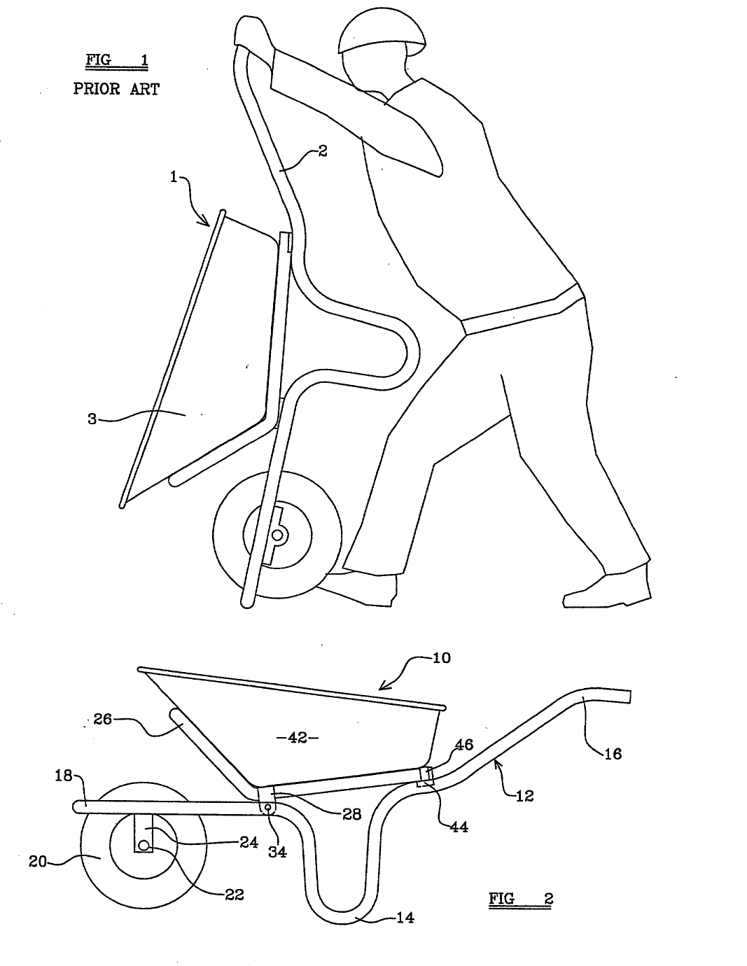

Referring first to FIG. 1, the disadvantage of a conventional prior art wheelbarrow 1 can be clearly seen. The user has to take handles 2 of the wheelbarrow 1 past the vertical to completely empty the load from a load carrying container or body 3, and if the load is heavy this can be very difficult. Furthermore, the position which has to be adopted by the user, very close to the wheelbarrow, can be quite unstable such that the wheelbarrow may tip over sideways during the emptying process spilling the load where it should not be and potentially causing injury to the user.

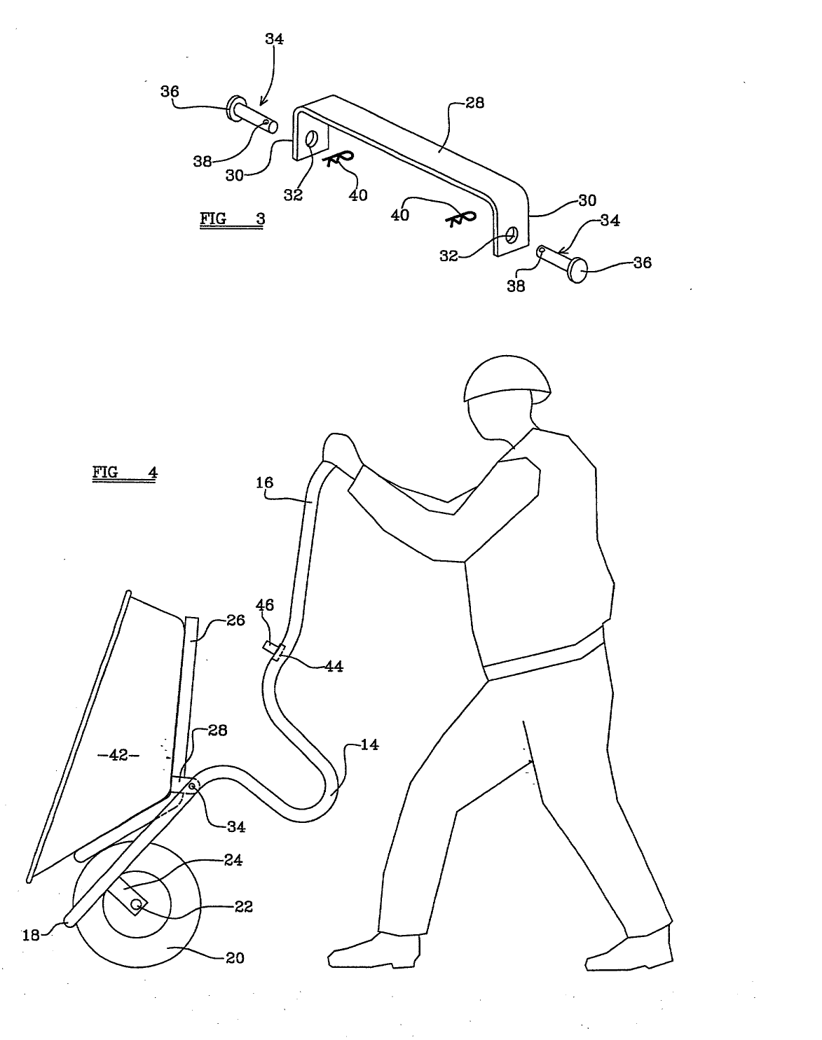

Referring now to FIGS. 2 to 4, a wheelbarrow 10 according to the invention includes a main frame 12, which provides a pair of ground engaging support portions 14 and a pair of rearwardly extending handles 16, and a U-shaped portion 18 at the front thereof. A single wheel 20 is pivotally mounted, by means of an axle 22, on the main frame 12 towards the front thereof. The axle 22 is supported below the main frame 12 by means of a pair of brackets 24 such that the wheel 20 only extends upwardly through the U-shaped portion 18 by a relatively small amount, i.e. in the illustrated embodiment approximately one third of the radius of the wheel 20.

The wheelbarrow 10 further includes a sub frame 26 which is pivotally secured to the main frame 12 rearwardly of the axle 22 and forwardly of the ground engaging support portions 14. The sub frame 26 has secured to it a cross member 28 with downturned end portions 30 each having a hole 32 provided therein. The main frame 12 has aligned holes provided for receipt of pins 34 through the holes in the main frame and the cross member 28 to secure the sub frame 26 to the main frame in a pivotable manner. The pins 34 have heads 36 and small holes 38 through them distant from the heads 36, and are retained in place by means of spring clips 40 inserted through the holes 38.

It will be appreciated that the construction of the wheelbarrow 10 means that the axle 22 is forward of and below the axis about which the body pivots, that is, an axis formed by the pins 34. However, at least a small part of the wheel extends above the plane in which the pins 34 are located.

The wheelbarrow 10 further includes a load carrying part or body 42 secured to the sub frame 26 to form a single body unit, by any appropriate means, such as welding. A cross member 44 is secured between the two sides of the main frame 12 just rearwardly of the ground engaging support portions 14, and forwardly of the handles 14. The cross member 44 supports the rear of the sub frame 26, and hence the body 42, when the wheelbarrow 10 is resting on the ground, as shown in FIG. 2, or is being pushed around in normal use.

Releasable clips 46, in the form of for example pipe clips, may be provided on the cross member 44 or the sub frame 26, or the body 42, to temporarily and selectively secure the body 42 with respect to the main frame 12, to prevent pivotal movement, during normal use. Releasable clips have the advantage that the sub frame 26 can automatically engage in them when returned to the use position from the tipped position. Furthermore, the spring clips may disengage when a predetermined force is applied to the body. The predetermined force will depend on how tight the spring clips are, and they could be provided such that if the wheelbarrow 10 is tipped with a full load in the body 42 that alone is sufficient to release the sub frame 26 from the clips 46.

However, such clips 46 are not really necessary as the weight of any load in the body 42 will generally keep it down onto the main frame 12. Preferably however, bearing pads will be provided where the sub frame 26 and/or body 42 contact the main frame 12 in order to avoid excessive wear to these components, and loud bangs as the body 42 returns to it's use position from it's tipped position. Such bearing pads may be made from any appropriate material, such as those which are relatively dense, but slightly resilient.

The use of pins 34 and spring clips 40 to secure the sub frame 26 and body 42 to the main frame 12 provides advantages in that the body 42 can readily be removed and replaced. This may be necessary if the original body 42 is damaged, as can often occur particularly on building sites, and is unlike conventional prior art wheelbarrows wherein the body is permanently secured to the frame. In addition the wheelbarrow 10 can be transported with the sub frame 26 and body 42 separate from the main frame 12, and then readily reassembled for use. This may be of assistance when delivering the product for sale, and for end users when transporting the wheelbarrow 10 between sites.

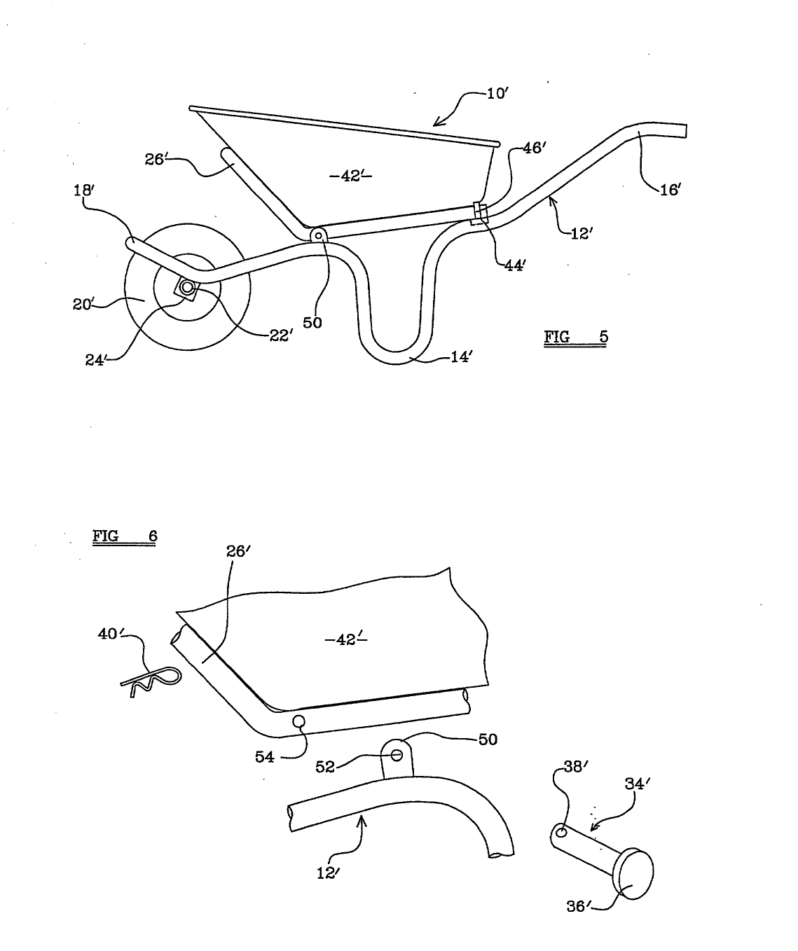

FIG. 4 shows the wheelbarrow 10 being emptied, and as can be seen, this is much easier for the user than in the prior art shown in FIG. 1. When the handles 16 are lifted, above the level required to push the wheelbarrow 10 in normal use, the weight of the body 42 and the load therein ensures that the body 42 tips away from the main frame 12 towards the wheel 20, until it comes into contact with the latter. This may, for example, provide a tip of approximately 30°. The user does not have to take the handles 16 past a position vertically above the axle 22 as in the prior art to achieve the same angle of the body 42 for emptying, and thus less effort is required. Indeed, depending on the exact geometry of the wheelbarrow 10 and the material comprising the load it may only be necessary for the user to lift the handles 16 such that they are approximately 40° to the horizontal. For example a free running load such as pea gravel will not require the same attitude of the body 42 for complete emptying as some other loads such as wet sand or grass cuttings. It should be appreciated that the body 42 will tip forward when handles 16 are lifted to the point that the center of mass of the body 42 and the load contained therein is forward of the pivot point formed by the pins 34.

It is also clear from FIG. 4 that the position adopted by the user is not so unstable as the position shown in FIG. 1, as the user does not have to stand so close to the wheel 20 or reach forward over the wheel, and is hence safer. Furthermore, the number of moving parts is minimized, when compared with prior art tipping wheelbarrows, thus limiting the potential for trapping of objects including hands and feet between such parts.

The arrangement of the wheelbarrow 10 provides a further very significant advantage in that the limit of the tip of the body 42 with respect to the main frame 12 is provided by the body 42, (and/or the sub frame 26) coming to rest on the wheel 20. This firstly means that, where the wheel 20 has a pneumatic tire, the contact when it occurs is slightly cushioned, preventing any jarring to the user. In addition and more importantly, it means that the contact on the wheel 20 tends to act as a brake on the wheel during the tipping process further stabilizing the wheelbarrow 10 during tipping and preventing it from continuing to roll forwards or indeed rolling backwards. This makes the wheelbarrow 10 much safer to use than many prior art tipping wheelbarrows.

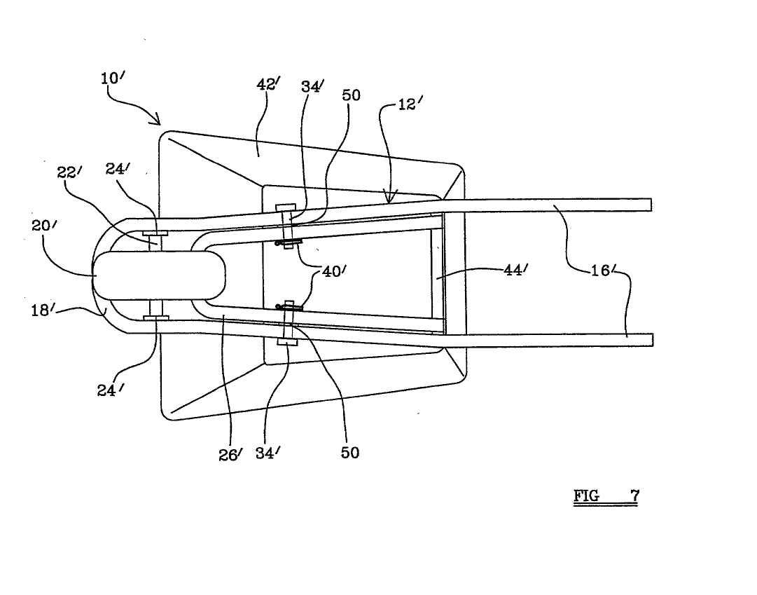

Referring now to FIGS. 5 to 7, an alternative embodiment of a wheelbarrow 10′ is illustrated, with parts common to the wheelbarrow 10 being like reference with the addition of a′. The wheelbarrow 10′ differs from the wheelbarrow 10 in some constructional details as will be described below, but operates exactly as described above.

The main frame 12′ of the wheelbarrow 10′ differs in that the portion extending between the ground engaging support portions 14′ and the U shaped portion 18′ at the front of the main frame is inclined downwardly and then upwardly rather than extending straight forwards. This shaping of the main frame 12′ enables the brackets 24′ supporting the axle 22′ to be significantly shorter than the brackets 24 which provides for greater stability and strength.

Furthermore, the arrangement thereby the sub frame 26′ and hence body 42′ are pivotally mounted on the main frame 12′ differs from that previously described, as can be best seen in FIG. 6. Pairs of brackets 50 bearing holes 52 are secured to the main frame 12′ forwardly of the ground engaging support portions 14′ and extending upwardly therefrom, on each side of the main frame 12′. Holes 54 are provided on each side of the sub frame 26′ which are aligned with the holes 52 when the sub frame 26′ and body 42′ are in appropriate relationship to the main frame 12′. Pins 34′ are inserted through the holes 52 and 54 and secured there by means of the spring clips 40′. This arrangement provides the advantages that, when the wheelbarrow 10′ is disassembled, there are no parts extending downwardly from the outside of the body 42′ and therefore a number of bodies 42′ can be stacked readily.

It will be appreciated that modifications may be made to the detailed construction of the wheelbarrows 10 and 10′ without departing from the scope of the present invention. For example the same general relationship between the wheel and the axis of pivot of the body may be achieved without the need for brackets 24 or 24′ if the main frame 12, 12′ is shaped differently forwardly of the attachment of the body 42, 42′ to the frame 12, 12′.

The embodiments described provide a tip of the body with respect to the main frame of about 30°. However the exact angle of tip will clearly depend on the exact configuration of the wheelbarrow concerned, in particular the relative positions of the axle and the axis of pivot of the body, the size of the wheel and the size and shape of the body. It is envisaged that angles of tip will generally be in the range of 20°-40°.

Although the embodiments described above each comprise a single wheel embodiments of wheelbarrows in accordance with the invention and incorporating twin wheels may be constructed without difficulty. In addition the main frame need not comprise a single elongate member bent to form the frame as in the embodiments described, but could comprise a plurality of components secured together by appropriate means.

Furthermore embodiments of wheelbarrows according to the invention need not include a sub frame, particularly if intended for lighter domestic use. In such embodiments the body unit will simply comprise the body and appropriate mounting means may be provided secured to the underside of the body.

Releasable clips 46, 46′ may also take many different forms. Rather than being simple pipe clips they may be of a form which the user has to operate to release or secure the body relative to the main frame. In such cases a release mechanism may be provided on the main frame adjacent to one or both handles.

In the present specification “comprise” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. A tipping wheelbarrow comprising:
a main frame having a front and including ground engaging support portions and a pair of rearwardly extending handles;
a wheel rotatably is mounted on an axle mounted on said main frame towards said front thereof;
a body unit for receipt of a load pivotally mounted on said main frame such that said body unit tips with respect to said mainframe when said handle means are lifted up, said body unit being mounted on said main frame for pivoting relative thereto about an axis rearwards of said axle and forwards of said ground engaging support portions of said main frame; and
wherein said wheelbarrow is constructed such that when said wheelbarrow is at rest on the ground, said axle is supported relative to said main frame forward of and below said axis about which said body unit pivots, wherein a portion of said wheel extends above said main frame, and wherein tipping of said body unit with respect to said main frame when said handles are lifted is limited by said body unit contacting said wheel.

2. A tipping wheelbarrow according to claim 1, and wherein said body unit includes a body secured to a sub frame, and wherein said sub frame is pivotally mounted on said main frame.

3. A tipping wheelbarrow according to claim 1, and wherein said main frame has a cross member rearwardly of said ground engaging support portions, said cross member supporting the rear of said body unit when not in a tipped position.

4. A tipping wheelbarrow according to claim 1, and wherein said wheelbarrow further includes means for selectively preventing pivotal movement of said body unit with respect to said main frame.

5. A tipping wheelbarrow according to claim 4, and wherein said means for selectively preventing pivotal movement of the body unit is automatically engageable.

6. A tipping wheelbarrow according to claim 5, and wherein said means for selectively preventing pivotal movement of said body unit is disengageable when a predetermined load is applied to said body.

7. A tipping wheelbarrow according to claim 1, and wherein said body unit is mounted on said main frame to pivot between 20° and 40°.

8. A tipping wheelbarrow according to claim 1, and wherein a portion of said wheel extends above said axis.
